(19) United States
(12) Patent Application Publication
(10) Pub. No.: US 2026/0086992 A1
(43) Pub. Date: Mar. 26, 2026

(54) Deep-Learning Solution to Building First-Party Identity Graphs from Third-Party Data

(71) Applicant: LiveRamp, Inc., San Francisco, CA (US)

(72) Inventors: Venkatesh Ramanathan, San Jose, CA (US); Jaipal Nenavath, Hyderabad (IN)

(21) Appl. No.: 19/397,184

(22) Filed: Nov. 21, 2025

Related U.S. Application Data
(63) Continuation of application No. PCT/US2025/047534, filed on Sep. 23, 2025.
(60) Provisional application No. 63/698,153, filed on Sep. 24, 2024.

(51) Int. Cl. G06F 16/22

(52) U.S. Cl. CPC G06F 16/2237

(57) ABSTRACT

A system and method for building first-party identity graphs using third-party data employs deep learning to enable privacy-preserving identity resolution. The system includes a deep learning model trained with transformer architecture and contrastive learning on a comprehensive third-party identity graph containing personally identifiable information (PII). Custom tokenizers process PII data by leveraging hierarchical structures and domain-specific characteristics to handle variations in spellings, abbreviations, and data formats. An identity matcher generates vector embeddings from first-party PII inputs, which are stored in a vector database for efficient similarity searches. A distributed similarity computation component compares first-party embeddings with third-party data embeddings, outputting similarity scores that enable fuzzy matching capabilities. A graph builder constructs accurate first-party identity graphs based on similarity thresholds while incorporating relevant third-party data.

### CROSS REFERENCE TO RELATED APPLICATIONS

This application is a continuation of International Patent Application No. PCT/US2025/047534, filed Sep. 23, 2025, which in turn claims priority to U.S. Provisional Ser. No. 63/698,153, filed on Sep. 24, 2024. Such applications are incorporated by reference herein.

### BACKGROUND OF THE INVENTION

Personally Identifiable Information (PII) refers to data that can be used to identify, contact, or locate a specific individual or user. This includes direct identifiers like names, addresses, and social security numbers, as well as indirect identifiers that can be combined with other information to identify a person.

A “touchpoint” may be any interaction or point of contact where an individual provides or generates data that can be used to identify that person across different systems or platforms. This could include online activities, transactions, customer service interactions, or any other instance where PII is collected or associated with a user profile.

A “payload” herein refers to the part of the input data (excluding the metadata) that is used to generate the output data.

Identity resolution is the process of combining multiple identifiers and data points across various touchpoints to create a unified, accurate profile of an individual user. It involves linking these disparate pieces of information from different sources to form a cohesive view of a person's identity across digital online and offline interactions.

Identity data is typically stored in an identity graph. An identity graph is a database that connects various data to a single user profile, enabling organizations to track and understand user behavior across different platforms and devices. An identity graph may be logically organized as a series of nodes connected by vertices, wherein nodes represent PII and/or touchpoints and vertices show the relationship between this data, tying data together that corresponds to a single user profile.

Identity graphs are often differentiated as being first-party, second-party, or third-party graphs. A first-party identity graph is one that is created and owned by a single organization using data collected directly from the users with which it interacts.

A second-party identity graph is the first-party graph of a different organization; the difference then between a first-party graph and a second-party graph is the point of view. Data may be shared from second-party identity graphs through a partnership between two or more organizations sharing their first-party data.

Third-party identity graphs contain data compiled by data aggregators using data from multiple sources, generally without direct relationships with the users. The owners of these third-party identity graphs may provide services to the owners of first-party graphs, whereby the first-party graphs are enhanced or improved in various ways using data from the provider's generally more comprehensive third-party graph.

The consolidation of an individual user's PII, touchpoints, and devices used by the individual into data graphs is a central aspect to identity-based messaging. This allows entities providing services to users to better understand individual users' needs and wants, and this better understanding of these individuals allows for more effective communication with the user by means of relevant messaging. However, consolidating PII data is particularly challenging due to variations in name spellings, typographical errors, changes in name, email, phone numbers, street addresses, sharing of email address, phone numbers, and street addresses, and erroneous, incomplete, or misleading data that is present in many data sources.

Even when the various discrepancies in PII have been resolved at a particular point in time, it may occur in the future that there are new changes or errors in an individual's PII, and thus the issue must be continually readdressed in the corresponding identity graph or graphs. In systems managing PII for hundreds of millions of individual users each with potentially thousands of individual items of PII, touchpoints, and the like, the problem becomes extremely computationally intensive due to the size of the identity graph. Due to the resulting computational complexity, the frequency of updates is limited by resource availability and cost.

In addition, any systems that manage PII, including identity graphs, must be designed to strictly safeguard such private data from loss or misuse. The necessity of enacting privacy restrictions and safeguards adds additional computational complexity to the problem, further limiting the ability of the owners of such systems to perform frequent updates due to cost and resource availability limitations.

### SUMMARY OF THE INVENTION

The invention is directed to a system and method configured to represent PII in a privacy-preserving format that can be used for identity resolution processes including but not limited to PII matching and touchpoint consolidation. The invention utilizes deep learning, which enables accurate matching of personally identifiable information (PII) while maintaining data security. The system employs a deep learning model trained with transformer architecture and contrastive learning on third-party identity graph data.

In certain embodiments, custom tokenizers process names, email addresses, phone numbers, and street addresses by leveraging hierarchical structures and domain-specific characteristics. The trained model generates vector embeddings that enable fuzzy matching, accounting for variations in spellings, typographical errors, and data inconsistencies. A vector database stores embeddings for nearest neighbor searches to identify potential identity matches.

In certain embodiments, the invention operates in a manner that accounts for abbreviations, short names versus long names, typographical errors, presence of name information within an email address, and the like.

In certain embodiments, the invention does not require data adhering to strict schema, but instead supports a flexible schema handler, and is also predictive in that it can account for future possible variations.

The invention has been found to increase match rates, thereby improving identity resolution.

The invention in certain embodiments can be used to build a more accurate first-party identity data graph by increasing the accuracy of connected data and validity of insights gleaned about the users whose data is present in the first-party data set, using a reference set of data from a third-party graph.

The invention in certain embodiments may increase the privacy and security of underlying PII data, such as by not requiring the movement of PII data from the first-party graph owner's own computing environment in order to perform matching in certain embodiments.

In one aspect, the invention is directed to a system for privacy-preserving identity resolution using deep learning, comprising a third-party identity graph containing personally identifiable information (PII) of a plurality of individuals including names, email addresses, telephone numbers, and street addresses; a deep learning model trained using transformer architecture and contrastive learning on data from the third-party identity graph; a plurality of custom tokenizers including a custom name tokenizer, a custom email tokenizer, a custom phone tokenizer, and a custom street address tokenizer, wherein each custom tokenizer leverages hierarchical structure and domain-specific characteristics of its respective data type; a vector database configured to store, index, and retrieve vector embeddings generated by the deep learning model; and an identity matcher configured to receive input PII data from a first-party data source; generate embeddings for the input PII data using the deep learning model; perform nearest neighbor vector search in the vector database to identify potential identity matches based on distance between embeddings; apply a match filter to determine if records correspond to the same individual; and generate a database of matched customer records.

In another aspect, the invention is directed to a method for privacy-preserving identity resolution using deep learning, comprising: training a deep learning model using transformer architecture on data from a third-party identity graph containing personally identifiable information (PII) of individuals; applying contrastive learning during training by providing each identity with both matching and non-matching information; tokenizing PII data using custom tokenizers that account for hierarchical structure and domain-specific characteristics; fine-tuning the deep learning model using identity-specific data; receiving input PII data from a first-party data source; generating vector embeddings for the input PII data using the trained deep learning model; storing the vector embeddings in a vector database; performing nearest neighbor vector search to identify potential identity matches; applying filtering logic to determine valid matches; and consolidating matched records to build a first-party identity graph.

In another aspect, the invention is directed to a system for identity matching, comprising: a deep learning model trained on a third-party identity graph; an identity matcher configured to: receive personally identifiable information (PII) inputs; and generate embeddings in the form of vectors based on the PII inputs using the deep learning model; a vector database configured to store, index, and retrieve vector data; a distributed similarity computation component configured to: take as input the embeddings; and output similarity scores between pairs of PII; and a match filter configured to decide if two particular records are considered a match based on the similarity scores.

In another aspect, the invention is directed to a method for identity matching, comprising: receiving personally identifiable information (PII) inputs; generating embeddings in the form of vectors of floating point values based on the PII inputs using a deep learning model trained on a third-party identity graph; storing, indexing, and retrieving the vector data in a vector database; and performing distributed similarity computation by: taking as input the embeddings; outputting similarity scores between pairs of PII; and applying a match filter to decide if two particular records are considered a match based on the similarity scores.

In another aspect, the invention is directed to a system for improving match rates in an identity resolution solution, comprising: a deep learning model trained on a third-party identity graph; an identity matcher configured to: receive personally identifiable information (PII) inputs; and generate embeddings in the form of vectors of floating point values based on the PII inputs using the deep learning model; a custom tokenizer configured to: process names to account for short names within longer names; identify names within email addresses; handle address abbreviations; and recognize hierarchical structures in addresses and telephone numbers; a fuzzy matching component configured to: compare embeddings to account for typographical errors; and match variations in name formats, including abbreviations and short versus long names; and a flexible schema handler configured to process input data without adhering to a strict schema, allowing for future variations in data representation.

In another aspect, the invention is directed to a method for improving match rates in identity resolution, comprising: receiving personally identifiable information (PII) inputs; tokenizing the PII inputs using a custom tokenizer that: processes names to account for short names within longer names; identifies names within email addresses; handles address abbreviations; and recognizes hierarchical structures in addresses and telephone numbers; generating embeddings in the form of vectors of floating point values based on the tokenized PII inputs using a deep learning model trained on a third-party identity graph; and performing fuzzy matching by: comparing embeddings to account for typographical errors; matching variations in name formats, including abbreviations and short versus long names; and processing input data without adhering to a strict schema, allowing for future variations in data representation.

In another aspect, the invention is directed to a system for identity resolution with record-level matching, comprising: a deep learning model trained on a third-party identity graph; an identity matcher configured to: receive record-level personally identifiable information (PII) inputs; and generate embeddings in the form of vectors of floating point values based on the record-level PII inputs using the deep learning model; a vector database configured to store, index, and retrieve vector data corresponding to record-level embeddings; a distributed similarity computation component configured to: take as input the record-level embeddings; and output similarity scores between pairs of records; and a record-level match filter configured to decide if two particular records are considered a match based on the similarity scores and record-level attributes.

In another aspect, the invention is directed to a method for record-level matching for identity resolution, comprising: receiving record-level personally identifiable information (PII) inputs; generating embeddings in the form of vectors of floating point values based on the record-level PII inputs using a deep learning model trained on a third-party identity graph; storing, indexing, and retrieving vector data corresponding to record-level embeddings in a vector database; performing distributed similarity computation by: taking as input the record-level embeddings; and outputting similarity scores between pairs of records; and applying a record-level match filter to decide if two particular records are considered a match based on the similarity scores and record-level attributes.

In another aspect, the invention is directed to a system for building first-party identity graphs using third-party data, comprising: a deep learning model trained on a third-party identity graph; an identity matcher configured to: receive first-party personally identifiable information (PII) inputs; and generate embeddings in the form of vectors of floating point values based on the first-party PII inputs using the deep learning model; a vector database configured to store, index, and retrieve vector data corresponding to the first-party PII embeddings; a distributed similarity computation component configured to: take as input the first-party PII embeddings; compare the first-party PII embeddings with third-party data embeddings; and output similarity scores between first-party and third-party data points; and a graph builder configured to: construct a first-party identity graph based on the similarity scores and a predefined threshold; and incorporate relevant third-party data into the first-party identity graph.

In another aspect, the invention is directed to a method for building first-party identity graphs using third-party data, comprising: receiving first-party personally identifiable information (PII) inputs; generating embeddings in the form of vectors of floating point values based on the first-party PII inputs using a deep learning model trained on a third-party identity graph; storing, indexing, and retrieving vector data corresponding to the first-party PII embeddings in a vector database; performing distributed similarity computation by: taking as input the first-party PII embeddings; comparing the first-party PII embeddings with third-party data embeddings; and outputting similarity scores between first-party and third-party data points; constructing a first-party identity graph based on the similarity scores; and incorporating relevant third-party data into the first-party identity graph.

In another aspect, the invention is directed to a system for scalable vector search for identity resolution, comprising: a deep learning model trained on identity data; an identity matcher configured to: receive personally identifiable information (PII) inputs; and generate embeddings in the form of vectors of floating point values based on the PII inputs using the deep learning model; a scalable vector database configured to: store and index a large volume of vector data corresponding to identity embeddings; and perform efficient similarity searches on the indexed vector data; a distributed similarity computation component configured to: take as input a query embedding; search the vector database for similar embeddings; and output a list of potential identity matches based on vector similarity; and a match filter configured to refine the list of potential identity matches based on predefined criteria.

In another aspect, the invention is directed to a method for scalable vector search in identity resolution, comprising: receiving personally identifiable information (PII) inputs; generating embeddings in the form of vectors of floating point values based on the PII inputs using a deep learning model trained on identity data; storing and indexing a large volume of vector data corresponding to identity embeddings in a scalable vector database; performing distributed similarity computation by: taking as input a query embedding; searching the vector database for similar embeddings; and outputting a list of potential identity matches based on vector similarity; and refining the list of potential identity matches based on predefined criteria using a match filter.

These and other features, objects and advantages of the present invention will become better understood from a consideration of the following detailed description of the preferred embodiments and appended claims in conjunction with the drawings as described following:

### BRIEF DESCRIPTION OF DRAWINGS

FIG. 1 is a diagram showing an overall architecture according to an embodiment of the present invention.

FIG. 2 is a diagram showing the architecture of an identity matcher according to an embodiment of the present invention.

FIG. 3 is a data flow diagram for a first-party graph build process according to an embodiment of the present invention.

FIG. 4 is a schematic for a computing component of a computing cluster for implementing an embodiment of the present invention.

### DETAILED DESCRIPTION OF THE INVENTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

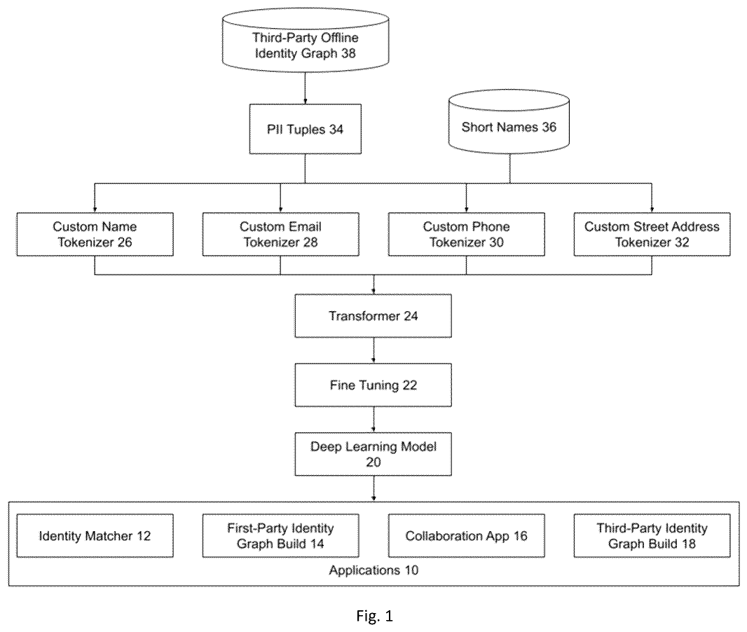

With reference now to FIG. 1, an embodiment of the invention using deep learning for identity resolution may be described. The data source used to begin processing is a third-party identity graph 38, preferably a third-party graph 38 that contains data for a great many users. One such data graph is maintained by LiveRamp, Inc. of San Francisco, California. The graph contains PII of individuals including names, email addresses, telephone numbers, street addresses, and their linkages. In addition, commonly used short names for given names and abbreviations associated with addresses may be used; this information is stored in short names database 36. Identity graph 38 is used as the primary source to build the deep-learning model 20.

Data preparation begins with a sample of identities (e.g., 10 million from the overall graph) and the corresponding name(s), email address(es), phone(s), and street address(es) from the identity graph 38, along with commonly used short names, for model training. In order to facilitate the learning process (known as “contrastive learning” in the machine learning literature) in certain embodiments, each identity is supplied with information belonging to that individual and information that does not belong to that individual (i.e., contrasting examples). The result is PII tuples 34.

Tokenization is the next step. Instead of randomly splitting data into fixed size tokens, a custom tokenizer is used. The custom tokenizer 26 leverages the fact that names can contain short names from short names database 36 within them; that email addresses could contain names within them; that addresses could be abbreviated or contain special types (such as PO Boxes); and that both addresses and telephone numbers have a hierarchical structure. For addresses, the hierarchical structure is reflected, for example, in the fact that several streets make up a city, several cities make up a state, etc. For telephone numbers, the hierarchical structure is the country code, area code, etc. This helps to optimize the parameters the model learns during the training process. The system uses separate custom tokenizers for these parameters, namely, customer name tokenizer 26, custom email tokenizer 28, custom phone tokenizer 30, and custom street address tokenizer 32.

The model is next trained using a variant of the deep-learning technique commonly known as transformer architecture, widely applied in natural language processing (NLP) tasks, at transformer 24. A specific learning paradigm, called contrastive learning, may be applied to minimize the loss function.

After training, fine tuning is applied to the model at fine tuning step 22. Pre-trained models available in the open source community do not have knowledge of how identities are represented and are not optimized for identity matching tasks. The model is thus fine-tuned using the identity data prepared at the data preparation step during fine tuning 22. After the deep learning model 20 is developed, it is then evaluated in a subset of the samples (referred to as the “hold out” set) that were not used for training.

Various applications 10 may utilize deep learning model 20. One application, identity matcher 12, is discussed further below. First-party graph build 14 is the application 10 that constructs a new first-party identity graph for a client of the provider using the client's data. Collaboration app 16 allows multiple parties to share their first-party identity graphs (which are, from the perspective of the other party, second-party data graphs) in order to gain insights concerning the data. Privacy protections are used in the collaboration app 16 such that no PII is transferred from one client to the other; data clean rooms may be used for this purpose. Third-party graph build 18 is the process of using deep learning model 20 to build a new third-party identity graph for various purposes.

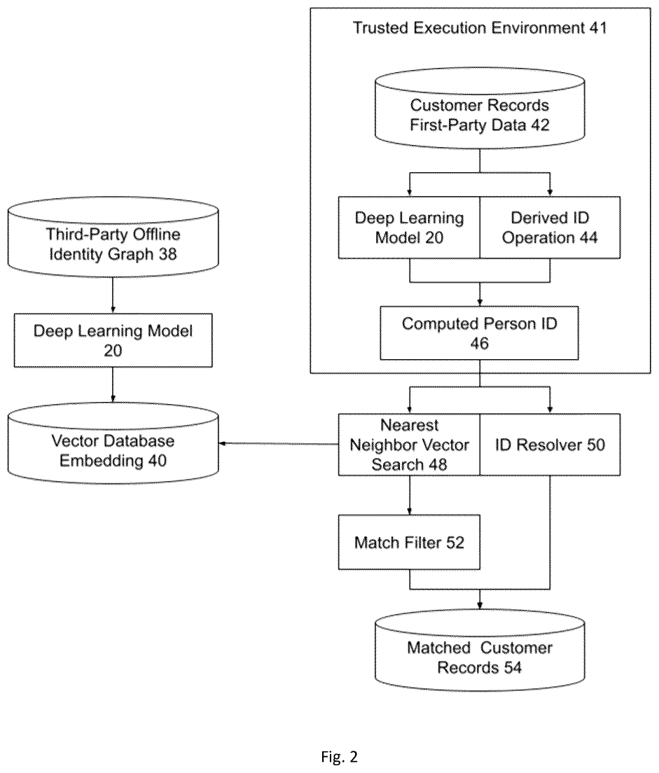

For deployment of the identity matcher 12 as shown in FIG. 2, deep learning model 20 consists of a containerized deployment of the inference model that accepts PII inputs and outputs embeddings in the form a vector of length N of 32-bit precision floating point values. Interacting with the deployed model is a vector database 40. The vector database 40 is capable of storing, indexing, and retrieving vector data. In an embodiment, the vector search capability of Google Cloud Platform (GCP)'s Big Query product was used, but the invention is not limited to this particular vector search implementation.

The vector search is used to generate a list of potential identity matches based on the distance between the input user record and the indexed identity graph records at nearest neighbor search 48. Shorter distances imply that the records are more likely to belong to the same individual.

In alternative embodiments, the length of the embedding vector can be increased or decreased, resulting in tradeoffs between accuracy and richness of the information encoded in the embedding over faster computation, vector search, and decreased payload sizes.

In alternative embodiments, the vector search over third-party offline identity graph 38 may be isolated to smaller and higher-value portions of the graph as opposed to indexing the entire graph, resulting in significantly faster performance with some marginal loss of match rate.

In any event, a match filter 52 is applied, which is a set of logic and data that can be used to decide if two particular records are considered a match. This filter is used for the prospect matches returned from the nearest neighbor vector search 48. In conjunction with ID resolver 50, the results of match filter 52 are applied to generate the database of matched customer records 54.

In certain embodiments, an optional isolated deployment of the model container can be made within a Virtual Private Cloud (VPC) controlled by one of the provider's customers for this service. This deployment strategy allows the customer to convert PII that it controls into an embedding (non-PII) within its environment. The embedding data is transmitted to the provider (alongside hashed and salted PII) for additional identity resolution. In this form, the embedding preserves the customer identity in the same manner as hashed PII (i.e., by transforming the raw PII using a non-reversible operation) but is not limited to exact matches (i.e., it has the additional advantage of matching to similar data).

Another optional deployment configuration used in certain embodiments is the trusted execution environment 41. This method additionally secures data by ensuring data is only decrypted in the CPU kernel during execution and providing proof that the software being executed has not been tampered with since verification. The process may use sets of identifiers developed by a particular identity resolution provider. These identifiers uniquely identify users within a large geographic area, such as a particular country. One such set of identifiers is the RampID® identifiers provided by LiveRamp, Inc.

The identifiers supplied by the provider and which are consistently associated with a particular user may be known as “maintained” identifiers. These identifiers are not created from raw PII, but rather are pointers into the provider's own third-party data graph, and present an individual (or possibly a household) as opposed to a specific PII representation. The invention may, in certain embodiments, also employ “derived” identifiers in addition to the maintained identifiers. The process for creating derived identifiers converts PII into a derived identifier through a set of non-reversible operations. Each derived identifier is created through a set of salting, hashing, and encryption operations to prevent loss of privacy when the derived identifiers are used.

The identity matcher 12 may be improved by adding PII embeddings to the payload that can be resolved using derived identifiers. The derived identifiers differ from maintained identifiers because they are generated from PII. Starting with customer records (first-party data) 42, deep learning model 20 is applied, along with the derived ID operation 44. (Note that deep learning model 20 is shown separately within the trusted execution environment 41 for clarity.) A computed person ID 46 is a combined payload of salted and hashed PII with the PII embedding and metadata about the type of PII and model version, further encrypted using a customer specific asymmetric encryption key. This is then used with nearest neighbor vector search 48 and ID resolver 50 as previously described.

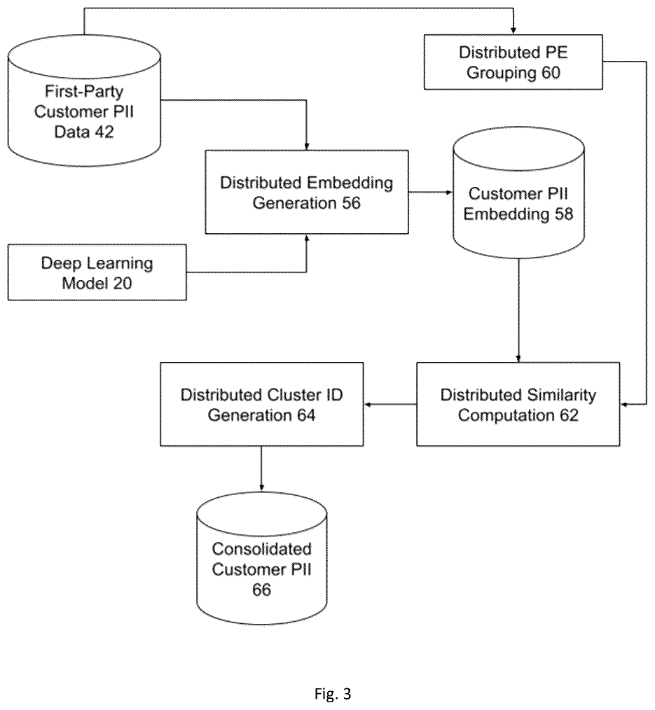

In order to generate embedding for customer PII in an efficient scalable manner, a distributed embedded generation component is used, as shown in FIG. 3. It may be, for example, implemented in the Apache Spark distributed computing framework, although the invention is not so limited. The distributed embedding generation interacts with both the first-party graph PII data 42 and the identity resolution provider's deep-learning model 20 as described above.

To determine if pairs of PII belong to the same individual user, a distributed score computation component takes as input embedding from distributed embedding generation 56 and creates a database of customer PII embedding 58. A distributed similarity computation 62 is used to compare the results in customer PII embedding 58 with a distributed PE grouping 60 generated from first-party customer PII data 42. This is the distributed similarity computation.

To generate unique identifiers for records that belong to the same individual in the embedding space, a scalable distributed component, the distributed cluster ID generation component 64, is used. In order to generate the cluster ID, the connected component 64 algorithm is run using record identifiers as vertices, and edges as pairs of records with a similarity score above a threshold, and the component label is used as the cluster identifier. The result is a database of consolidated customer PII 66, which may be used to build the first-party customer identity graph.

In certain embodiments, the embedding may be used to connect first-party and second-party data (i.e., someone else's first-party data) for collaboration, without exposing the underlying PII and without creating a persistent third-party identifier. This allows two entities that maintain user data to collaborate without revealing any PII concerning their respective users.

The developed methodology as described above facilitates fuzzy matching thereby resulting in a net absolute match rate improvement of approximately 3%, based on client data testing. This contributes to increased revenue and decreased processing time for the provider of the service.

The developed methodology allows for non-movement of PII data, which increases the security of the sensitive data by keeping it confined to its compute environment that is secured by the data controller and consequently increases privacy for the consumer by decreasing the risk of data exfiltration.

The developed methodology allows for third-party graph context-specific criteria to be leveraged when building a first-party graph without exposing the sensitive data to either the first or third party. The first-party graph build additionally takes advantage of the fuzzy matching that accounts for variations in the data representation as well as future possible variations.

The developed methodology and technology increases the match rate of derived ID joins and resolution by bringing into the matching logic the fuzzy attributes and distance calculations, where otherwise the system would rely upon exact key matching.

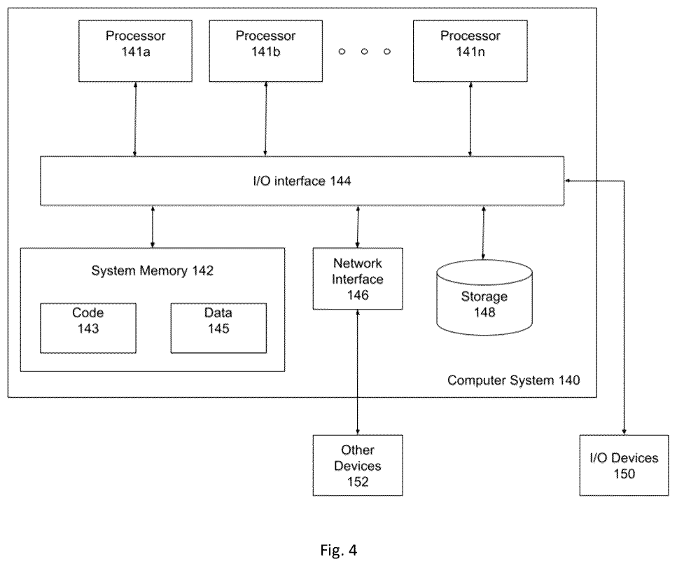

The methods described herein may in various embodiments be implemented by any combination of hardware and software. For example, in one embodiment, the methods may be implemented by a computer system (e.g., a computer system as in FIG. 4) or a collection of computer systems, each of which includes one or more hardware processors executing program instructions stored on a computer-readable physical storage medium coupled to the hardware processors, within the provider environment 10 and the customer environment 14. The program instructions may implement the functionality described herein (e.g., the functionality of various hardware servers and other components that implement the network-based cloud and non-cloud computing resources described herein). The various methods as illustrated in the figures and described herein represent example implementations. The order of any method may be changed, and various elements may be added, modified, or omitted.

FIG. 4 is a block diagram illustrating an example computer hardware system, according to various embodiments. Computer system 140 may implement a hardware portion of a cloud computing system as forming parts of the various implementations of the present invention. Computer system 140 may be any of various types of hardware devices, including, but not limited to, a commodity server, personal computer system, desktop computer, laptop or notebook computer, mainframe computer system, handheld computer, workstation, network computer, a consumer device, application server, physical storage device, telephone, mobile telephone, or in general any type of computing node, compute node, compute device, and/or hardware computing device.

Computer system 140 includes one or more hardware processors 140a, 141b . . . 141n (any of which may include multiple processing cores, which may be single or multi-threaded) coupled to a physical system memory 142 via an input/output (I/O) interface 144. Computer system 140 further may include a network interface 146 coupled to I/O interface 144. In various embodiments, computer system 140 may be a single processor system including one hardware processor 141a, or a multiprocessor system including multiple hardware processors 141a, 141b . . . 141n as illustrated in FIG. 4.

Processors 141a, etc. may be any suitable processors capable of executing computing instructions. For example, in various embodiments, processors 141a, etc. may be general-purpose or embedded processors implementing any of a variety of instruction set architectures. In multiprocessor systems, each of processors 141a, etc. may commonly, but not necessarily, implement the same instruction set. The computer system 140 also includes one or more hardware network communication devices (e.g., network interface 146) for communicating with other systems and/or components over a communications network, such as a local area network, wide area network, or the Internet. For example, a client application executing on system 140 may use network interface 146 to communicate with a server application executing on a single hardware server or on a cluster of hardware servers that implement one or more of the components of the systems described herein in a cloud computing environment as implemented in various sub-systems. In another example, an instance of a server application executing on computer system 140 may use network interface 146 to communicate with other instances of an application that may be implemented on other computer systems.

In the illustrated embodiment, computer system 140 also includes one or more physical persistent storage devices 148 and/or one or more I/O devices 150. In various embodiments, persistent storage devices 148 may correspond to disk drives, tape drives, solid-state memory or drives, other mass storage devices, or any other persistent storage devices. Computer system 140 (or a distributed application or operating system operating thereon) may store instructions and/or data in persistent storage devices 148, as desired, and may retrieve the stored instructions and/or data as needed. For example, in some embodiments, computer system 140 may implement one or more nodes of a control plane or control system, and persistent storage 148 may include the solid-state drives (SSDs) attached to that server node. Multiple computer systems 140 may share the same persistent storage devices 148 or may share a pool of persistent storage devices, with the devices in the pool representing the same or different storage technologies, including such technologies as described above.

Computer system 140 includes one or more physical system memories 142 that may store code/instructions 143 and data 145 accessible by processor(s) 141a, etc. The system memories 142 may include multiple levels of memory and memory caches in a system designed to swap information in memories based on access speed, for example. The interleaving and swapping may extend to persistent storage devices 148 in a virtual memory implementation, where memory space is mapped onto the persistent storage devices 148.

The technologies used to implement the system memories 142 may include, by way of example, static random-access memory (RAM), dynamic RAM, read-only memory (ROM), non-volatile memory, solid-state memory, or flash-type memory. As with persistent storage devices 148, multiple computer systems 140 may share the same system memory systems 142 or may share a pool of system memories 142. System memory or memory systems 142 may contain program instructions 143 that are executable by processor(s) 141a, etc. to implement the routines described herein.

In various embodiments, program instructions 143 may be encoded in binary, Assembly language, any interpreted language such as Java, compiled languages such as C/C++, or in any combination thereof; the particular languages given here are only examples. In some embodiments, program instructions 143 may implement multiple separate clients, server nodes, and/or other components.

In some implementations, program instructions 143 may include instructions executable to implement an operating system (not shown), which may be any of various operating systems, such as UNIX, LINUX, Solaris™, MacOS™, or Microsoft Windows™. Any or all of program instructions 143 may be provided as a computer program product, or software, that may include a non-transitory computer-readable storage medium having stored thereon instructions, which may be used to program a computer system (or other electronic devices) to perform a process according to various implementations.

A non-transitory computer-readable storage medium may include any mechanism for storing information in a form (e.g., software or processing application) readable by a machine (e.g., a physical computer). Generally speaking, a non-transitory computer-accessible medium may include computer-readable storage media or memory media such as magnetic or optical media, e.g., disk or DVD/CD-ROM, coupled to or in communication with computer system 140 via I/O interface 144. A non-transitory computer-readable storage medium may also include any volatile or non-volatile media such as RAM or ROM that may be included in some embodiments of computer system 140 as system memory 142 or another type of memory.

In other implementations, program instructions may be communicated using optical, acoustical or other form of propagated signals (e.g., carrier waves, infrared signals, digital signals, etc.) conveyed via a communication medium such as a network and/or a wired or wireless link, such as may be implemented via network interface 606. Network interface 146 may be used to interface with other devices 142, which may include other computer systems or any type of external electronic device.

In some embodiments, system memory 142 may include data store 145, as described herein. In general, system memory 142 and persistent storage 148 may be accessible on other devices 142 through a network and may store data blocks, replicas of data blocks, metadata associated with data blocks, and/or their state, database configuration information, and/or any other information usable in implementing the routines described herein.

In one embodiment, I/O interface 144 may coordinate I/O traffic between processors 141a, etc., system memory 142, and any peripheral devices in the system, including through network interface 146 or other peripheral interfaces. In some embodiments, I/O interface 144 may perform any necessary protocol, timing or other data transformations to convert data signals from one component (e.g., system memory 142) into a format suitable for use by another component (e.g., processors 141a, etc.). In some embodiments, I/O interface 144 may include support for devices attached through various types of peripheral buses, such as a variant of the Peripheral Component Interconnect (PCI) bus standard or the Universal Serial Bus (USB) standard, as examples. Also, in some embodiments, some or all of the functionality of I/O interface 144, such as an interface to system memory 142, may be incorporated directly into processor(s) 141a, etc.

Network interface 146 may allow data to be exchanged between computer system 140 and other devices attached to a network, such as other computer systems (which may implement one or more storage system server nodes, primary nodes, read-only node nodes, and/or clients of the database systems described herein), for example. In addition, I/O interface 144 may allow communication between computer system 140 and various I/O devices 150 and/or remote storage 148. Input/output devices 150 may, in some embodiments, include one or more display terminals, keyboards, keypads, touchpads, scanning devices, voice or optical recognition devices, or any other devices suitable for entering or retrieving data by one or more computer systems 140. These may connect directly to a particular computer system 140 or generally connect to multiple computer systems 140 in a cloud computing environment, grid computing environment, or other system involving multiple computer systems 140.

Multiple input/output devices 150 may be present in communication with computer system 140 or may be distributed on various nodes of a distributed system that includes computer system 140. In some embodiments, similar input/output devices may be separate from computer system 140 and may interact with one or more nodes of a distributed system that includes computer system 140 through a wired or wireless connection, such as over network interface 146.

Network interface 146 may commonly support one or more wireless networking protocols (e.g., Wi-Fi/IEEE 802.11, or another wireless networking standard). Network interface 146 may support communication via any suitable wired or wireless general data networks, such as other types of Ethernet networks, for example. Additionally, network interface 146 may support communication via telecommunications/telephony networks such as analog voice networks or digital fiber communications networks, via storage area networks such as Fibre Channel SANs, or via any other suitable type of network and/or protocol.

In various embodiments, computer system 140 may include more, fewer, or different components than those illustrated in FIG. 4 (e.g., displays, video cards, audio cards, peripheral devices, or an Ethernet interface).

Any of the distributed system embodiments described herein, or any of their components, may be implemented as one or more network-based services in the cloud computing environment. For example, a read-write node and/or read-only nodes within the database tier of a hardware database system may present database services and/or other types of physical data storage services that employ the distributed storage systems described herein to clients as network-based services.

In some embodiments, a network-based service may be implemented by a software and/or hardware system designed to support interoperable machine-to-machine interaction over a network. A web service may have an interface described in a machine-processable format. Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol. To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

Unless otherwise stated, all technical and scientific terms used herein have the same meaning as commonly understood by one of ordinary skill in the art to which this invention belongs.

Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context.

When a grouping is used herein, all individual members of the group and all combinations and sub-combinations possible of the group are intended to be individually included.

When a range is stated herein, the range is intended to include all sub-ranges within the range, as well as all individual points within the range.

When “about,” “approximately,” or like terms are used herein, they are intended to include amounts, measurements, or the like that do not depart significantly from the expressly stated amount, measurement, or the like, such that the stated purpose of the apparatus or process is not lost.

All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A system for building first-party identity graphs using third-party data, comprising:
a deep learning model trained on a third-party identity graph;
an identity matcher configured to:
receive first-party personally identifiable information (PII) inputs; and
generate embeddings in the form of vectors of floating point values based on the first-party PII inputs using the deep learning model;
a vector database configured to store, index, and retrieve vector data corresponding to the first-party PII embeddings;
a distributed similarity computation component configured to:
take as input the first-party PII embeddings;
compare the first-party PII embeddings with third-party data embeddings; and
output similarity scores between first-party and third-party data points; and
a graph builder configured to:
construct a first-party identity graph based on the similarity scores and a predefined threshold; and
incorporate relevant third-party data into the first-party identity graph.

2. The system of claim 1, wherein the deep learning model is trained using contrastive learning on the third-party identity graph to improve differentiation between similar but distinct identities.

3. The system of claim 1, wherein the identity matcher is configured to generate embeddings that preserve similarities between different representations of the same identity across first-party and third-party data.

4. The system of claim 1, further comprising a custom tokenizer configured to process first-party PII data, including names with variations in format and spelling, email addresses containing name information, addresses with abbreviations and variations, and telephone numbers with hierarchical information.

5. The system of claim 1, wherein the distributed similarity computation component is configured to efficiently process large volumes of first-party and third-party identity data.

6. The system of claim 1, wherein the graph builder is configured to apply context-specific criteria when incorporating third-party data into the first-party identity graph.

7. The system of claim 1, further comprising a flexible schema handler configured to process input data without adhering to a strict schema, allowing for variations in data structure and content across first-party and third-party sources.

8. The system of claim 1, wherein the system is configured to build the first-party identity graph without requiring movement of raw first-party PII data outside a secure environment.

9. The system of claim 1, further comprising a distributed cluster ID generation component configured to generate unique identifiers for entities that appear in both first-party and third-party data.

10. A method for building first-party identity graphs using third-party data, comprising:
receiving first-party personally identifiable information (PII) inputs;
generating embeddings in the form of vectors of floating point values based on the first-party PII inputs using a deep learning model trained on a third-party identity graph;
storing, indexing, and retrieving vector data corresponding to the first-party PII embeddings in a vector database;
performing distributed similarity computation by:
taking as input the first-party PII embeddings;
comparing the first-party PII embeddings with third-party data embeddings; and
outputting similarity scores between first-party and third-party data points; constructing a first-party identity graph based on the similarity scores; and incorporating relevant third-party data into the first-party identity graph.

11. The method of claim 10, further comprising training the deep learning model using contrastive learning on the third-party identity graph to improve differentiation between similar but distinct identities.

12. The method of claim 10, wherein generating embeddings preserves similarities between different representations of the same identity across first-party and third-party data.

13. The method of claim 10, further comprising tokenizing the first-party PII inputs using a custom tokenizer configured to process names with variations in format and spelling, email addresses containing name information, addresses with abbreviations and variations, and telephone numbers with hierarchical information.

14. The method of claim 10, wherein performing distributed similarity computation includes efficiently processing large volumes of first-party and third-party identity data.

15. The method of claim 10, wherein incorporating relevant third-party data into the first-party identity graph includes applying context-specific criteria.

16. The method of claim 10, further comprising processing input data without adhering to a strict schema, thus allowing for variations in data structure and content across first-party and third-party sources.

17. The method of claim 10, further comprising building the first-party identity graph without requiring movement of raw first-party PII data outside a secure environment.

18. The method of claim 10, further comprising generating unique identifiers for entities that appear in both first-party and third-party data using a distributed cluster ID generation component.

19. The method of claim 10, further comprising updating the first-party identity graph incrementally as new first-party data becomes available, using the deep learning model to generate embeddings for the new data and incorporating it into the existing graph structure.

20. The method of claim 10, further comprising using the first-party identity graph to enhance first-party data with relevant third-party information while maintaining privacy and security of the underlying PII data.
